(19) United States
(12) Patent Application Publication
(10) Pub. No.: US 2009/0157498 A1
(43) Pub. Date: Jun. 18, 2009

(54) GENERATIONAL INTELLIGENT NAVIGATION SYNCHRONIZATION OR UPDATE

(75) Inventors: Michael Lewis Seltzer, Seattle, WA (US); John C. Krumm, Redmond, WA (US); Jeffrey D. Couckuyt, Bothell, WA (US); Ivan J. Tashev, Kirkland, WA (US); Ruston Panabaker, Redmond, WA (US); Neil W. Black, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/957,151

(22) Filed: Dec. 14, 2007

(51) Int. Cl. G01C 21/34; G06Q 30/00

(52) U.S. Cl. 705/14; 701/201; 705/1

(57) ABSTRACT

A direction set can be augmented with up-to-date information such that a route to be taken by a user is changed. A user can request a direction set to take a user along a long route that minimizes cost to a user. A route can be generated using a set of known fuel prices; however, as the user travels, fuel prices can change. New fuel information can be gathered and the route can be modified based upon the gathered information.

### CROSS-REFERENCE

This application relates to U.S. patent application draft with Attorney Docket No. MSFTP2086US entitled “ROUTE MONETIZATION”.

This application relates to U.S. patent application draft with Attorney Docket No. MSFTP2087US entitled “FEDERATED ROUTE PRODUCTION”.

This application relates to U.S. patent application draft with Attorney Docket No. MSFTP2088US entitled “DESTINATION AUCTIONED THROUGH BUSINESS OF INTEREST”.

This application relates to U.S. patent application draft with Attorney Docket No. MSFTP2090US entitled “SOCIAL NETWORK BASED ROUTES”.

This application relates to U.S. patent application draft with Attorney Docket No. MSFTP2091US entitled “ROUTE TRANSFER BETWEEN DEVICES”.

This application relates to U.S. patent application draft with Attorney Docket No. MSFTP2092US entitled “ADDITIONAL CONTENT BASED ON INTENDED TRAVEL DESTINATION”.

This application relates to U.S. patent application draft with Attorney Docket No. MSFTP2093US entitled “AUTOMATIC SPLICES FOR TARGETED ADVERTISEMENTS”.

This application relates to U.S. patent application draft with Attorney Docket No. MSFTP2094US entitled “PEDESTRIAN ROUTE PRODUCTION”.

This application relates to U.S. patent application draft with Attorney Docket No. MSFTP2095US entitled “ROUTE GENERATION BASED UPON ACTIVITY CRITERIA”.

### TECHNICAL FIELD

The subject specification relates generally to route modification and in particular to updating a route with current information.

### BACKGROUND

Computer-driven route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a municipality, state/providence, and/or country, proximity of the point of interest to major freeways, proximity of the point of interest to a specific city, and the like.

Furthermore, conventional computer-implemented mapping applications often include route-planning applications that can be utilized to provide users with directions between different locations. Pursuant to an example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she wishes to avoid highways. Similarly, a user can inform the route planning application that she wishes to travel on a shortest route, or a route that takes a least amount of time, or the car will consume least amount of gas (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

In conventional route generation, a user inputs a starting location and intended destination as well as several constraints concerning a route (e.g., shortest amount of time, avoiding highways, etc.). Based upon the user input as well as contextual data (e.g., mapping information), a route can be generated. For example, the route can be generated on a home computer, a copy of the route can be printed onto paper and the paper is taken with a user to a vehicle and followed to reach a destination. One major flaw with conventional practice is that once the route is generated the route is not keep up-to-date and thus a user could be relegated to follow a route based upon old information.

The subject specification discloses information toward updating a direction set with current information. Commonly, an update includes altering the direction set to take a user upon different roads to achieve an economic goal. Information can be collected and evaluated to determine if a change should be made upon a direction set to make the direction set more current. If it is determined that a change should be made, then an appropriate alteration can take place upon the direction set.

Practice of the disclosed innovation would be in different direction than directions followed by many in the route generation industry. General industry thought is towards producing an improved database that is used to generate a route—thus a goal is to make as high quality of an initial route as possible. It would seem illogical to alter a route based upon changing data due to the focus on improving route generation databases. Unexpected results can occur from practice of the subject specification such that quality directions are provided with minimal detriment to the user. This is unexpected since so much focus has been on database improvement that it would appear changing a route would provide numerous difficulties, such as confusing the user since the direction set is changed.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative direction set alteration system in accordance with the subject specification.

FIG. 2 illustrates a representative direction set alteration system with a detail analysis component in accordance with the subject specification.

FIG. 3 illustrates a representative direction set alteration system with a detailed modification component in accordance with the subject specification.

FIG. 4 illustrates a representative direction set alteration system with various additional components in accordance with the subject specification.

FIG. 5 illustrates a representative direction set alteration system in accordance with the subject specification.

FIG. 6 illustrates a representative route alteration methodology in accordance with the subject specification.

FIG. 7 illustrates a representative information identification methodology in accordance with the subject specification.

FIG. 8 illustrates a representative route amendment methodology in accordance with the subject specification.

FIG. 9 illustrates an example of a schematic block diagram of a computing environment in accordance with the subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. When a component, unit, module, etc. makes an inference or determination, it is to be appreciated that the inference or determination can be performed through utilization of artificial intelligence techniques.

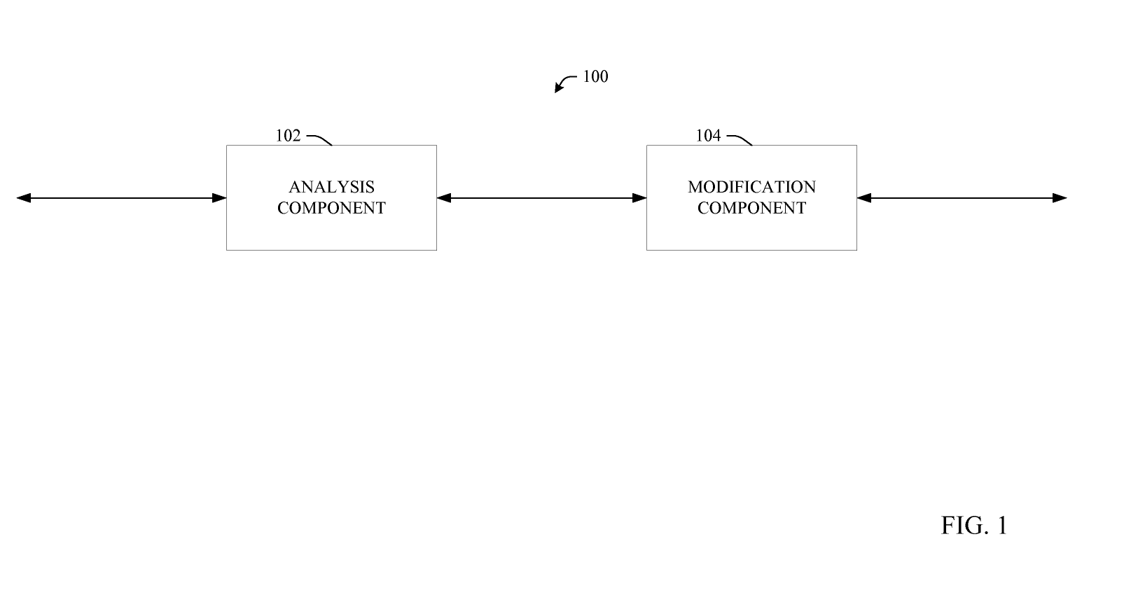

Now referring to FIG. 1, an example system 100 is disclosed for altering a route with current information. Commonly, a route is generated for a user though user interaction with a route generation device (e.g., in-vehicle system, desktop computer, personal digital assistant, etc.). For instance, a user enters a starting point and intended destination requesting that a route be generated that is most economical when traveling in a vehicle (e.g., automobile, motorcycle, bicycle, airplane, helicopter, motorboat, self-balancing transportation device, etc.), often an automobile. A route can be produced that takes into account fuel prices, such that a user will spend little money on fuel. However, as the user travels, conditions can change (the traffic conditions, for example, which heavily affect the gas consumption, even the fuel prices) and thus route becomes outdated and does not meet an original goal. In addition, elements that are more dynamic can influence a route; as weather patterns change, a route designed to achieve a goal can be altered in order to become more effective. For example, if a route goal is that a route be safest, icy road conditions can be continuously changing and influence routes a user should take, a lane of a road a user should travel upon, and the like. Practice of the disclosed innovation allows for information to be updated and a route to be modified in order to keep with a goal.

An initial route can be collected by an analysis component 102 and evaluated to determine information that can be subject to change, such as traffic patterns, economic information, and the like. Based upon an evaluation result, the analysis component 102 can search for sources with a relatively high likelihood of producing modern information. Requests can be made to the sources to produce information and request results can be obtained. The analysis component 102 can evaluate if obtained information is more relevant than information applied to a direction set. If the information is not more relevant, then the direction set can remain unchanged.

If obtained information is determined to be more relevant than information used in initial direction set generation, then a modification component 104 can alter the direction set based upon a subset of obtained information (e.g., all obtained information, a portion of obtained information, a derivative of obtained information such as a calculated result, and so forth) that is more relevant. For example, a user can intend to travel from New York, N.Y. to Seattle, Wash. by automobile and request that a route be generated through an in-vehicle navigation system. The user can implement advanced routing where economic considerations are taken into account as well as other factors. For instance, the user can ask the route to make overnight stops after about fifteen hours of driving. A route can be generated that locates a hotel with a vacancy for an estimated twelve-hour driving block.

As the user travels, contextual changes can take place that can impact a route: a user cannot drive at an expected pace, vacancies can be filled, hotel rates can change, and so on. The analysis component 102 can identify that the route was based on information that could change and perform periodic checks to determine if there have been changes. In the example, a different hotel can advertise a cheaper rate than initially offered, thus being cheaper than a hotel used in route generation. The modification component 104 can determine the information is more relevant and perform calculations to determine if the route should be changed. The route can be altered such that the cheaper hotel is made a stop as opposed to the initial hotel. While the route itself can be altered, independently a route description can also be altered. If weather conditions change and visibility lowers, then visual indicators can be changed to mileage indicators—as opposed to instructing the user to turn right at the green oak tree the user can be instructed to turn right in about two and one-third miles.

According to one embodiment, a user path is not changed, but there is a change to direction set metadata (e.g., data that concerns and is part of the direction set). For example, a hotel price for a hotel along a route can be lowered—while the route does not change the price changes and thus an even lower price would need to be supplied for a route to be modified and thus an appropriate change can be made by the modification component 104. Additionally, the metadata can change when there is an impact to a route, but not enough of an impact to justify an alteration. If an initial hotel price rises, but another route cannot be created that is more economical (e.g., fuel uses costs would outweigh the price difference), then the route can remain the same and a modification is made to route metadata.

Implementation of the system 100 can produce user-specific results—when traveling between two points at one time, a user wanting premium fuel can be provided a different route then a user that desires regular fuel. Evaluation of obtained information can determine if the obtained information is more relevant to a user (e.g., as opposed to a public as a whole, a group in a vehicle, and the like). While aspects of the subject specification discuss a user requesting to have a route provided, it is to be appreciated that route generation can use principles disclosed and a route can be updated automatically without user request. For instance, when a user starts a vehicle, the system 100 can automatically attempt to gain up-to-date information and modify routes accordingly.

Evaluation can take place to determine if obtained information is more reliable then information used to produce (e.g., generate, previously modify, . . . ) the direction set and if obtained information is more reliable, then the direction set is altered with the obtained information. In an illustrative example, initially when a route is produced, a news television program weather report with forecasts is used to output a route that considers road safety—however, the weather report can be several hours old. As a user travels, she can receive a signal from a government weather service with real-time weather information. Since a government service can be considered more reliable then a television program or real-time information is more reliable then forecasts/old data, the obtained information can be used to alter the direction set since it is from a more reliable source or the information itself is more reliable.

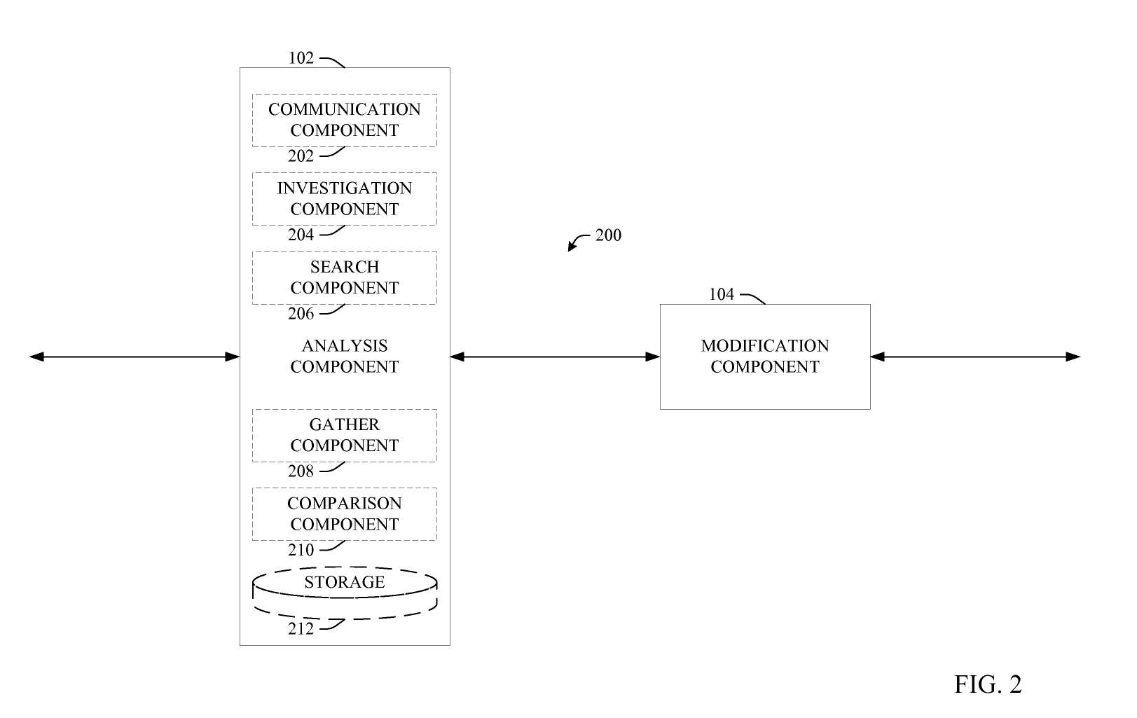

Now referring to FIG. 2, an example direction set alteration system 100 is shown with a representative detailed analysis component 102. A communication component 202 can engage with other devices to transfer information, such as to send a request for information, receiving information from an auxiliary source, etc. Operation can take place wirelessly, in a hard-wired manner, employment of security technology (e.g., encryption, authentication), etc. Moreover, the communication component 202 can utilize various protective features, such as performing a virus scan on obtained data and blocking information that is positive for a virus. The information can be obtained actively (e.g., by querying the information source) or passively (e.g., by monitoring a stream of broadcasted data and selecting the relevant parts, by getting notifications from the information source when there is a relevant change, and so forth).

A route can be examined (e.g., continuously, periodically, etc.) by an investigation component 204 to identify information that is likely to change in a direction set. Some direction set information can be dynamic (e.g., traffic patterns) while other information rarely changes (e.g., street names). The investigation component 204 identifies common dynamic information and infers when update checks should take place. For example, fuel prices can change daily, so the investigation component 204 can request that a fuel price check take place once a day. In addition, the investigation component 204 can determine if route information is inconsistent (e.g., fuel data used in generation is several times lower then generally accepted prices), learn modifications in operation of a vehicle operating a system 200 (e.g., presumed fuel mileage estimates are different in practice), etc. According to one embodiment, the investigation component 204 can subscribe to a service that provides data (e.g., traffic data) and the service transfers real-time updates as information changes.

To gather information (e.g., from an auxiliary source), a search component 206 can be employed to locate a source that provides information that can be obtained. A source can be a database server, an airway transmission, an incoming electronic message, etc. Multiple sources can provide conflicting information and the search component 206 can include logic that resolves conflict issues (e.g., information is downloaded from a source with a history of being highly trustworthy.)

A request can be provided from a gather component 208 to the source that the source provide specific information (e.g., hotel price information). Moreover, the gather component 208 can obtain information (e.g., from a source, off open airwaves, through a directed transmission/download, etc.) that is ultimately evaluated to determine if a route modification should be made.

A comparison component 210 can evaluate obtained information against route information to determine if an alteration should take place. For instance, a nominal change in fuel prices would likely not be beneficial in altering a route since other costs would cancel the change. The comparisons component 210 determines the small likelihood and cancels a proposition for altering.

Different pieces of information, such as obtained information, component operating instructions (e.g., of the search component 206), an original route, etc. can be held on storage 212. Storage 212 can arrange in a number of different configurations, including as random access memory, battery-backed memory, hard disk, magnetic tape, etc. Various features can be implemented upon storage 212, such as compression and automatic back up (e.g., use of a Redundant Array of Independent Drives configuration). Obtained information, evaluation results (e.g., results of the comparison component 210), and the like can be processed by a modification component 104.

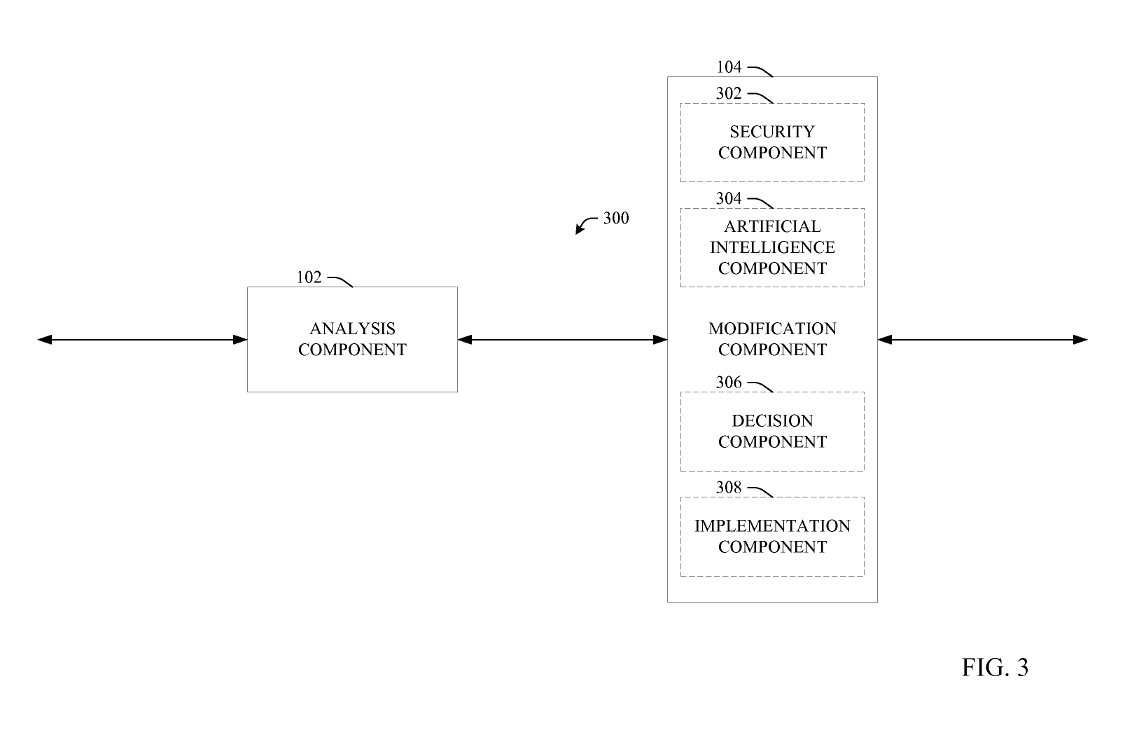

Now referring to FIG. 3 an example direction set alteration system 300 is shown with a representative detailed modification component 104. It is possible that obtained information is not from a reputable source and a security component 302 can be employed that concludes if obtained information is from a trustworthy source. Alteration of the direction set can be blocked if obtained information is not from a trustworthy source. The security component 302 can use various forms of logic to determine validity of a source. In one example, information is blocked unless the source is verifiable; there is a list of acceptable sources, the security component 302 checks if the source is on the list and if the source is not, then the information is blocked and no change is made. However, the security component 302 can perform a determination if information is questionable (e.g., there are inconsistencies) and information is not blocked unless a problem is raised.

An artificial intelligence component 304 can make at least one inference or at least one determination in relation to the obtained information evaluation or the direction set alteration. For example, the artificial intelligence component 304 can infer that a gasoline station central server will produce gasoline prices and the server is a viable source. In addition, the artificial intelligence component 304 can determine an appropriate alteration that should be made upon a route.

Artificial intelligence component 304 can employ one of numerous methodologies for learning from data and then drawing inferences and/or creating making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

Information that passes through the security component 302 can be used to alter a direction set. A decision component 306 can determine a modification that should take place upon the direction set, such as altering a route, changing metadata, and the like. For example, information can be received that a road has closed upon an intended route. The decision component 306 can determine there is a road that runs parallel to the closed road (e.g., though accessing a central server) and that a route should be modified that takes the user along the parallel road. The decision component 306 can also perform analysis to determine a specific modification that should be made (e.g., instructions on how to take a user along the parallel road).

Decisions concerning direction set alteration can be placed into effect by an implementation component 308. For instance, the implementation component 308 can delete closed road instructions and integrate parallel road instructions in the deleted space. Moreover, the implementation component 308 can run consistency checks to ensure there were no dependency issues (e.g., a user was to stop for fuel along the closed road and the new route does not disclose how the user will stop for fuel) and perform actions to resolve discovered dependency issues.

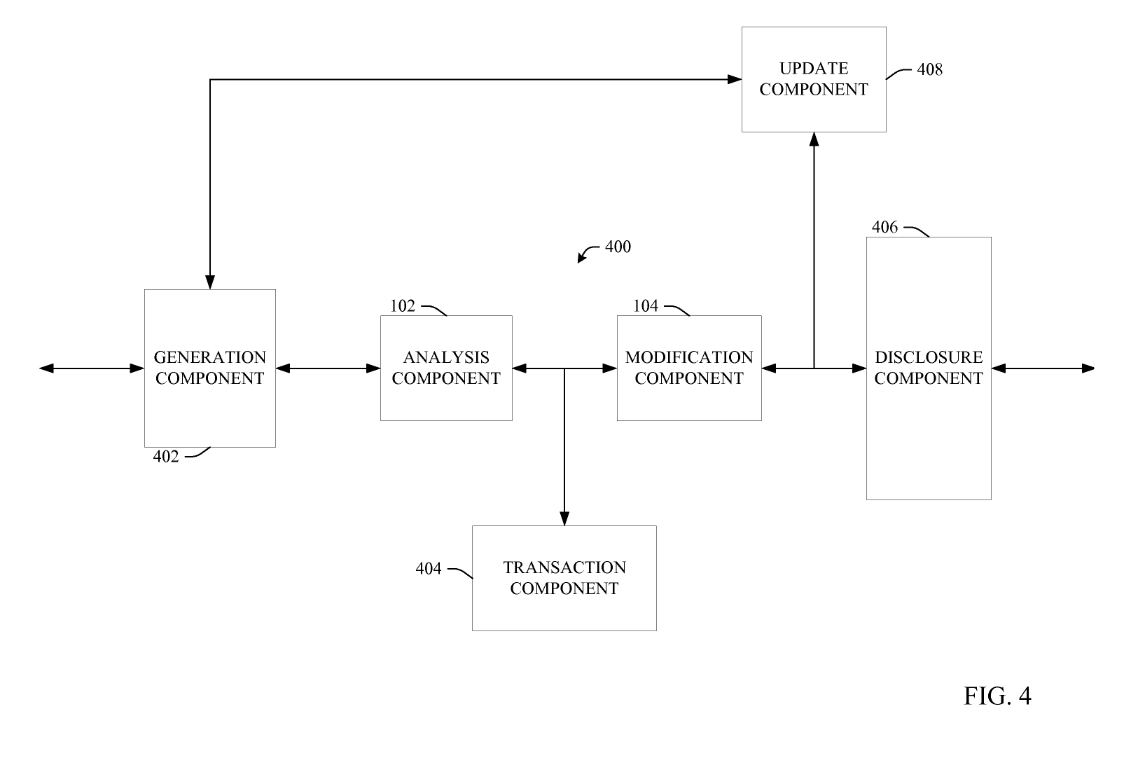

Now referring to FIG. 4, an example system 400 for route alteration is disclosed with various components capable of enhancing functionality. A generation component 402 can construct a route though various manners (e.g., database searches and best route determination) and be implemented upon various devices (e.g., in-vehicle, personal electronic devices, etc.) The generation component 402 can predict an intended destination of a user through analysis of user history, sensor data, etc. For instance, at 5 PM on weekdays, a user typically drives from her office to her home; a route can be constructed automatically by the generation component 402 based on this information. In addition, the generation component 402 can use operator requested information, such as making a route between three points (e.g., starting, destination, waypoint, etc.) that is most economical.

A constructed route and metadata can be processed by an analysis component 102 that evaluates the route and determines information that was used in generation that could be subject to change. The analysis component 102 can gather data related to information that is subject to change (e.g., if determined data is food prices, new food price data can be obtained) and evaluate if obtained information is more relevant than information applied to a direction set.

Based upon evaluation results, the modification component 104 can alter the direction set through use of information that is more relevant. According to one embodiment, alteration of a direction set can take place automatically after a user has followed at least a portion of the direction set. In addition, alteration can take place upon a portion of the direction set not yet traveled by a user during a travel session. For example, a user can often travel between his home and office. A travel session can be one instance of the user traveling between the home and office. Moreover, alteration of the direction set can be performed to improve economic viability of the direction set.

Use of information towards alteration can be subject to financial/reward constraints that are processed by a transaction component 404 that can perform a reward (e.g., financial, non-financial, etc.) operation in relation to information obtainment or direction set alteration. An entity can require payment for providing information, for using information to update the generation component 402, to alter a route, etc. The transaction component 404 can perform actions to meet constraints, such as debiting a user account and crediting a provider account. While fiscal amounts are commonly transacted, it is to be appreciated that other commodities can be exchanged, such as coupons, meeting of contractual obligations (e.g., canceling of debts), tax credits, etc.

Moreover, a reward operation can take place in relation to user response to a commercial detail (e.g., presented with a pedestrian route). For example, an advertisement can be played that a user should stop at a highway exit for a cup of coffee. If the user takes the exit, buys the cup of coffee, buys a different item, etc., then payments of varying amounts can be made to an advertisement hosting service.

As new information is determined to be more relevant, operation of the generation component 402 can be changed by an update component 408. Functioning of the update component 408 enables use of more relevant information by the generation component 402. The update component 408 can send new information to the generation component 402 as well as send instruction on how operation should be improved (e.g., a notice that a road should no longer be used, that a closed shipping lane is now open, etc.). Another situation when the update component 408 can activate the generation component 402 is when the driver (accidentally or intentionally) diverges from the generated route. Then the update component 408 signals the generation component to generate route from the current point to the end point using the same optimization criteria.

A direction set altered by the modification component 104 can be presented to the user through a disclosure component 406. A disclosure component 406 allows an individual to appreciate a direction set and act upon the direction set. A non-exhaustive list of disclosure components include a display screen, touch screen, speaker system, virtual reality environment, Braille production system, printer, etc. In addition, the disclosure component 406 can present information in multiple formats, such as showing a video with audio capabilities. Moreover, a user can be asked if she wants to have a change made to a direction set based upon newly learned information, and her response can be provided through the disclosure component 406. The modification component 406 can configure to alter a route automatically when a user takes a path that is not included in a route (e.g., by accident, because the user has found a point of interest that causes a deviation from the route, and the like).

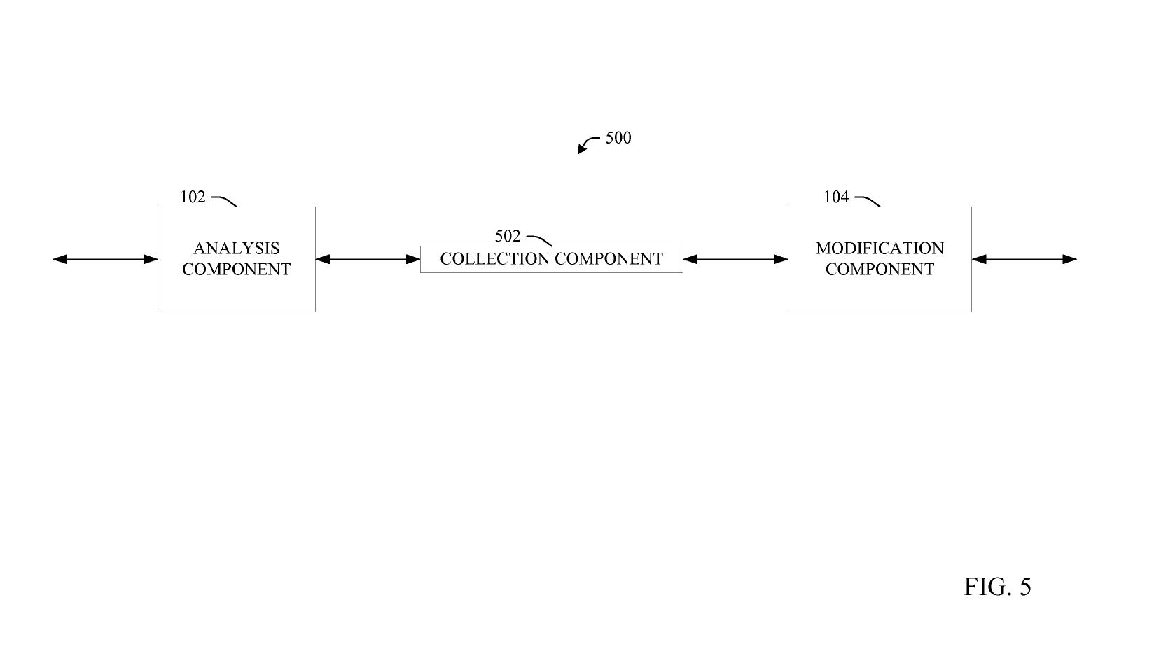

Now referring to FIG. 5, a system 500 is disclosed for altering a direction set based upon newly obtained information that is more relevant than information used in creating the direction set or previously altering the direction set. A generated route can be obtained by an analysis component 102 and the analysis component 102 evaluates the route in order to find information that is likely to have changed since a previous alteration or generation. The analysis component 102 can function as a means for identifying route information that is no longer current.

A collection component 502 can obtain information from various sources (e.g., databases, local storage, and the like) that can be used to replace out-of-date data. The collection component 502 can operate as a means for collecting information that can be used to replace the route information that is no longer current. Functionality of the gather component 208 of FIG. 2 can be exploited by the collection component 502 and visa versa. Information obtained from the collection component 502 can be extracted by the analysis component 102 to evaluate if obtained information is more relevant then information applied to a direction set.

Evaluation results can be processed by a modification component 104 and an appropriate alteration upon a direction set can be made. Alteration can include creating a new direction set based upon an original direction set as well as making changes to at least a portion of an original direction set. The modification component 104 can implement as a means for amending the route information that is no longer current with collected information.

According to one embodiment, the collection component 502 initially operates to find data without regards to a direction set. The collection component 502 can determine what types/locations to search in order to find appropriate information such that the system 500 does not become overloaded. Obtained data can transfer to the analysis component 102 and the analysis component 102 uses the obtained data to determine if route information is no longer current (e.g., data used to generate a route is old, a new road has been built that can be used by a user, etc.), such as through use of the comparison component 210 of FIG. 2. Identified information as well as potential alterations to be made can transfer to the modification component 104 such that an appropriate alteration can take place.

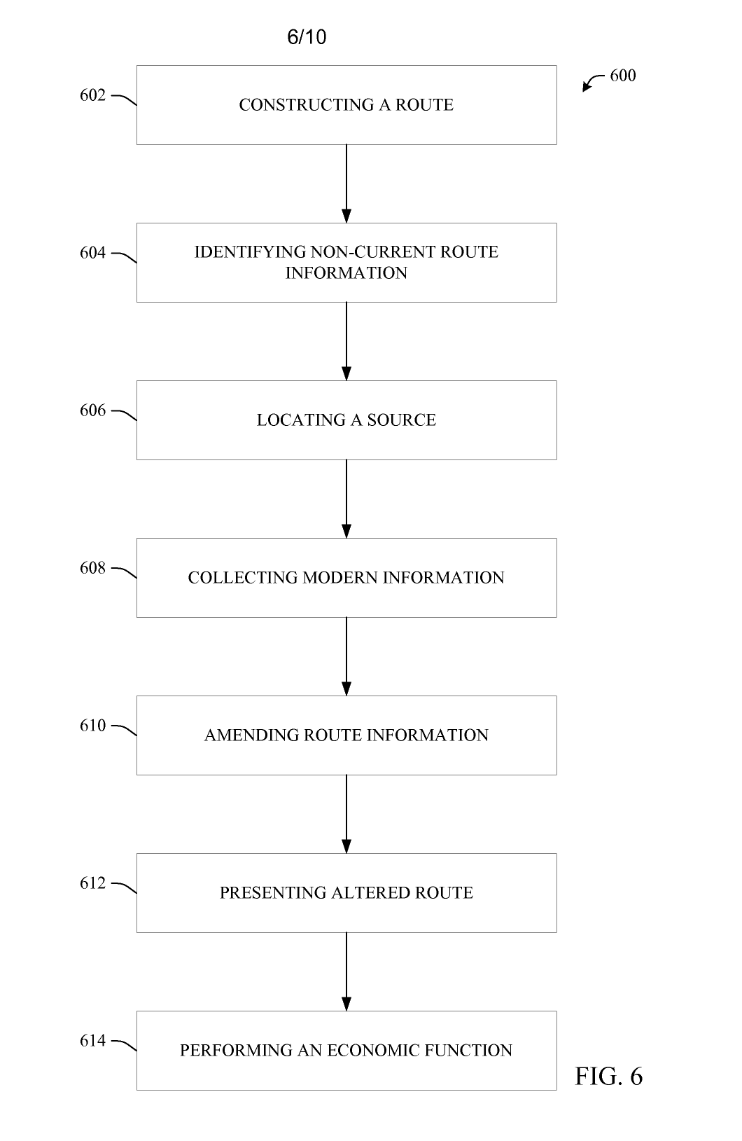

FIG. 6 discloses an example methodology 600 for altering a route based upon new information (e.g., newly discovered information, changed information, and the like). At event 602, a route can be constructed commonly taking a user between at least two points. The route can be built off information retained in local storage, an initial information gathering action, and so on.

At block 604, there can be identifying route information that is no longer current. Information that is no longer current can include data that has since changed (e.g., a hotel room price), information that was not known at construction time or time of last alteration (e.g., a new source is discovered with information that is older than information used in construction), etc. Identification can take place through detailed analysis of a route, comparison of the route against obtained information, performing probability calculations, and the like.

With information identified as out-of date, detailed searches can be performed to find locations capable of producing modern information at action 606. Internet Protocol addresses can be held in storage of locations that commonly have current information. For instance, news channel servers can have a history of holding modern traffic information and addresses for the servers can be retained in storage. Internet Protocol addresses of these servers can be accessed and used to locate the servers.

At act 608, modern information can be collected from discovered sources. Information collection can take place through downloading data from a source, copying information into local storage, extraction, monitoring airwaves, and the like. Various protective features can be implemented through information gathering, such as scanning for viruses, performing accuracy checks, comparing information from multiple sources (e.g., three traffic reports from three news channels), resolving inconsistencies (e.g., choosing information to use from multiple inconsistent sources). It is to be appreciated that identifying non-current information at block 604 can take place after action 606 or act 608

Event 610 allows for amending the route information that is no longer current with modern information. Amendment can include changing the route as well as constructing a new route based upon an old route. For example, a route section can be deleted and a new section can be created in the open place based upon newly learned information.

An altered route can be presented to the user at action 612. Common presentation includes disclosure though a navigation system or through picture/video or sound. However, other configurations are possible, such as making a paper copy through a printer. The presentation can include interaction with a user, for example, asking a user if she approves of a change made.

At block 614, various financial transactions can take place in accordance with operations of the methodology 600. Since information is commonly changing hands from one party to another, money can be paid to different parties. For instance, a company running the methodology 600 can pay money to a data source from the ability to extract information over a period.

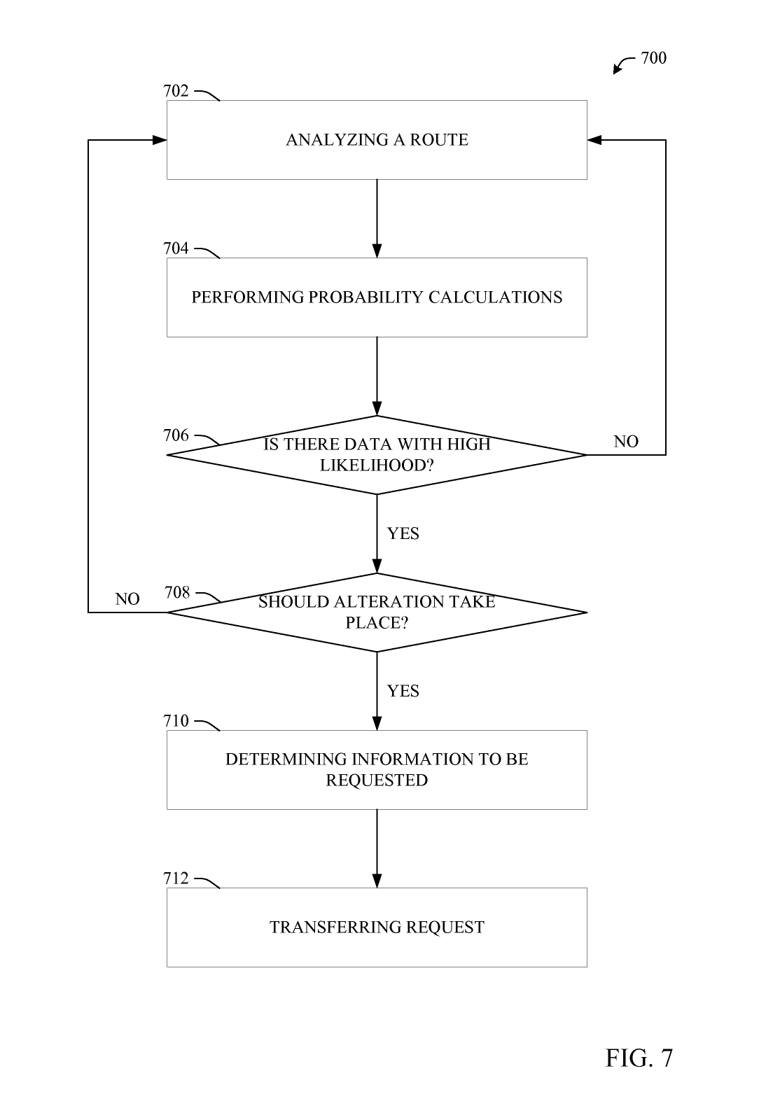

FIG. 7 discloses an example methodology 700 for identifying route information that is no longer current, which is one representative implementation of block 604 of FIG. 6. A route can be analyzed at event 702 to ascertain information sections that are likely to be impacted by out-of-date information. For instance, a route portion that was selected due to heavy traffic patterns can be signaled through event 702.

At block 704, probability calculations can take place that estimates a likelihood that route information will change. For example, there can be a high probability that fuel prices will change while there is a low probability there will be heavy traffic in a rural town. Different portions of a route, information pieces associated with a route, etc. can be assigned a probability that information will change.

A check 706 can take place to determine if information has a relatively high probability of having a change that should influence a route. If there is no information that has a likelihood of having an influential change, then the methodology 700 can return to event 702 where route analysis can continue in case of a change in the route. However, information identified as a high probability can allow the methodology 700 to move on; high probability can be determined off a threshold standard, compared to other pieces of information, etc.

Verification 708 determines if a route alteration can take place 708. For instance, if new information would not produce a different result (e.g., it does not matter how heavy traffic is, there is one road available), then the methodology 700 can return to event 702. However, if it is determined that an alteration should take place, the methodology 700 can continue.

At action 710, a determination can be made as to what information should be requested that could be used to update a route. A wide variety of information can be collected and used to alter a route. However, a specific request can be made so valuable information is obtained quickly and resources of a system running the methodology 700 can be saved since there is less information to process.

A request can be transferred at event 712 that enables information gathering. For example, the request can indicate to a source what information the methodology 700 would like to receive. The request can include various features, such as financial information (e.g., an account from which a source can debit if information is provided) or security clearance data.

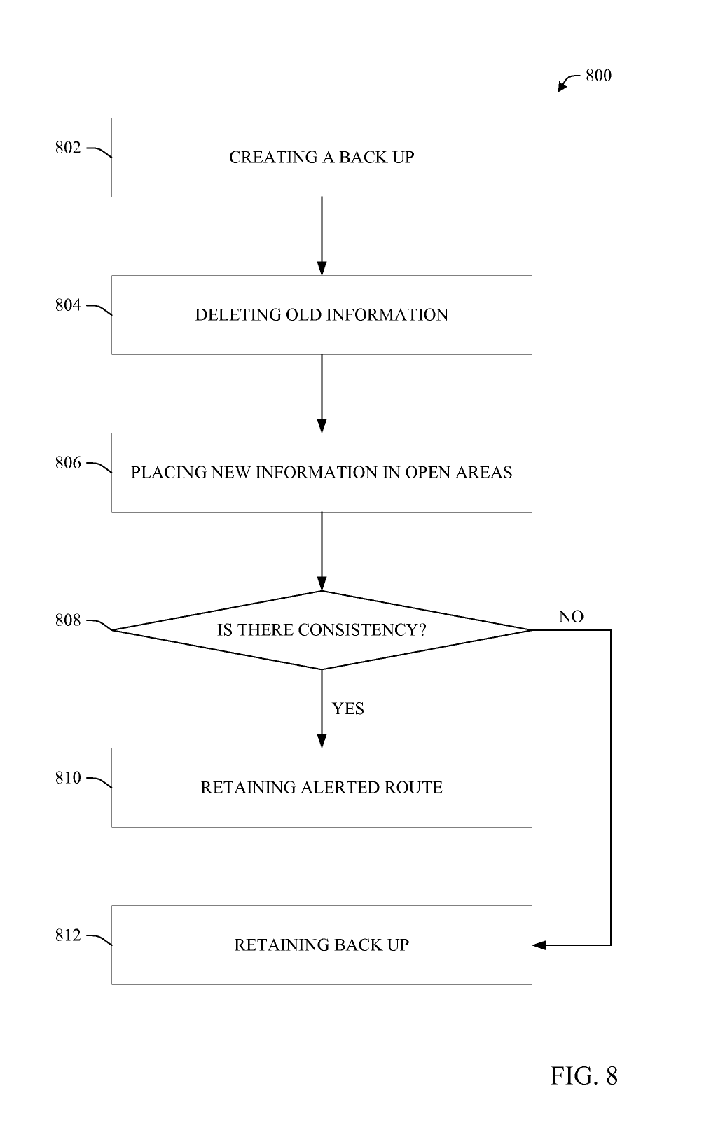

FIG. 8 discloses an example methodology 800 for amending the route information that is no longer current with modern information, which is one representative implementation of event 610 of FIG. 6. Since a route is likely to be altered through the methodology 800, a back-up of an initial route can be retained at act 802. The retained back up can be saved in storage and referred to when alterations are taking place.

Old route information can be deleted at action 804, which can include route information as well as metadata used to produce the route. For example, if a route intended to be highly economical uses a road with a gasoline station that has low prices and the prices change, then the road can be deleted in the route as well as a retained gasoline price. A check can take place to ensure a user will not become confused by the deletion (e.g., the methodology 800 takes place at a point before a user sees a specific route portion).

A determination can be made as to what information should be placed in an open area and the information is placed in the open area at action 806. For instance, a route can have an open area in place for travel between two cities from action 804. Action 806 can determine a new manner in which to travel between the cities and place the new route in the open space; for instance, a highway can be placed in as opposed to non-highways.

A check 808 can take place to determine if there is consistency in a newly created route. It is possible for changes to take place in a route that result in inconsistencies; for example, deletion of a portion can eliminate a planned activity of a user since a road is not included taking the user to the activity. An attempt can be made to resolve inconsistencies and an amended route can be retained for usage at event 810. However, if consistencies cannot be resolved (e.g., a user makes it a requirement to perform an activity, a user does not approve of an altered route, etc.), then a back up route can be retained at action 812 (e.g., use of the route created at act 802).

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media. Moreover, while a subset of the subject specification discloses operation of aspects though utilization of a vehicle, it is to be appreciated aspects can be practiced through alternative manners (e.g., walking, swimming, etc.)

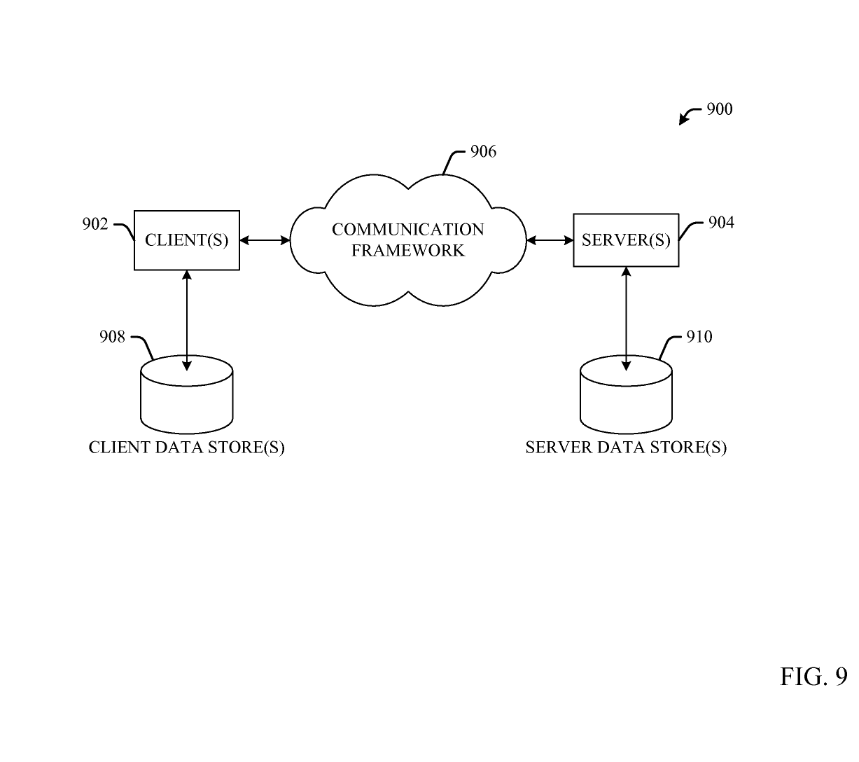

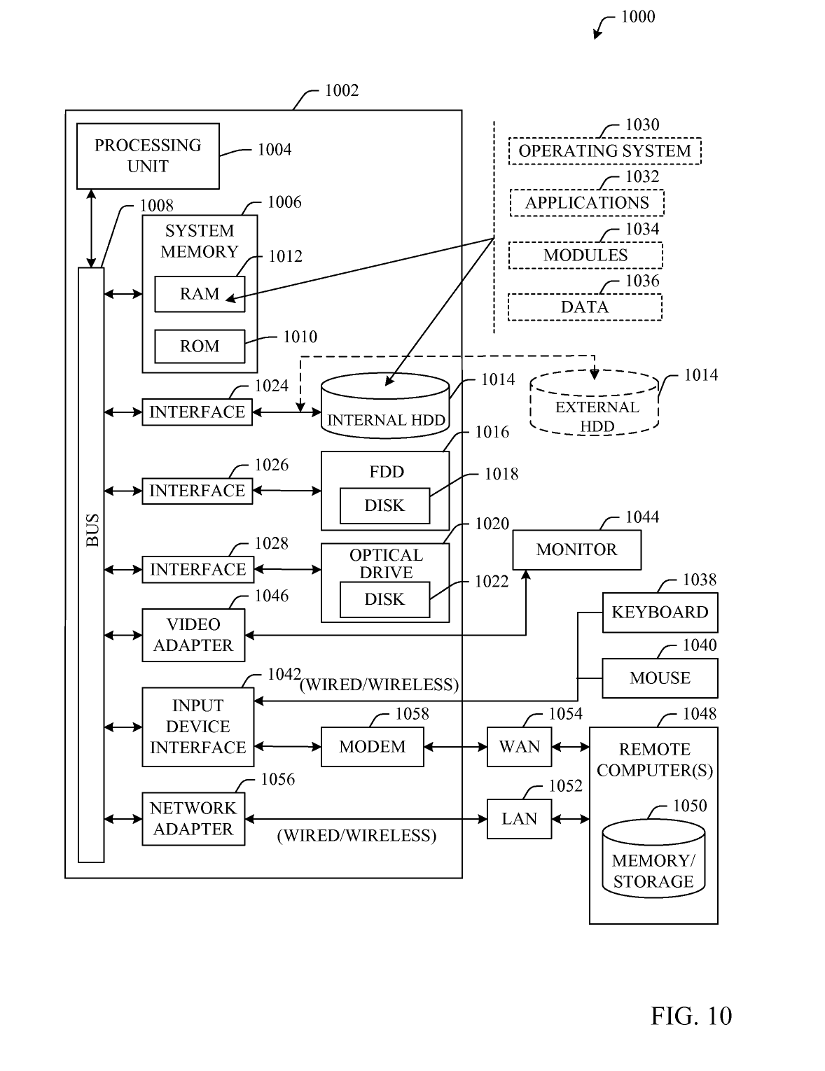

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an analysis component that evaluates if obtained information is more relevant than information applied to a direction set; and
a modification component that alters the direction set based upon a subset of obtained information that is more relevant.

2. The system of claim 1, alteration of a direction set takes place automatically after a user has followed at least a portion of the direction set.

3. The system of claim 1, alteration takes place upon a portion of the direction set not yet traveled by a user during a travel session.

4. The system of claim 1, alteration of the direction set is performed to improve economic viability of the direction set.

5. The system of claim 1, further comprising a gather component that obtains information that is evaluated.

6. The system of claim 5, further comprising a search component that locates a source that provides information that can be obtained.

7. The system of claim 5, further comprising a transaction component that performs a reward operation in relation to information obtainment or direction set alteration.

8. The system of claim 1, further comprising a disclosure component that presents the directions set.

9. The system of claim 1, further comprising a generation component that produces the direction set.

10. The system of claim 9, further comprising an update component that modifies generation component operation to enable use of more relevant information.

11. The system of claim 1, further comprising a security component that concludes if obtained information is from a trustworthy source, alteration of the direction set is blocked if obtained information is not from a trustworthy source.

12. The system of claim 1, evaluation takes place to determine if obtained information is more reliable than information used to produce the direction set and if obtained information is more reliable, then the direction set is altered with the obtained information.

13. The system of claim 1, evaluation of obtained information determines if the obtained information is more relevant to a user.

14. A method, comprising:
identifying route information that is no longer current; and
amending the route information that is no longer current with modem information.

15. The method of claim 14, further comprising collecting the modem information.

16. The method of claim 15, further comprising locating at least one source of the modem information, modem information is collected from at least one located source.

17. The method of claim 14, further comprising presenting a route with modem information to a user.

18. The method of claim 14, further comprising performing an economic function in relation to route information identification or route amendment.

19. A system, comprising:
means for identifying route information that is no longer current; and
means for collecting information that can be used to replace the route information that is no longer current.

20. The system of claim 19, further composing means for amending the route information that is no longer current with collected information.
